(19) United States
(12) Patent Application Publication
(10) Pub. No.: US 2005/0040302 A1
(43) Pub. Date: Feb. 24, 2005

(54) Chelsea swing arm system assembly

(76) Inventor: Kermit Roger Spalding, Nacogdoches, TX (US)

Correspondence Address: KERMIT ROGER SPALDING, P.O. BOX 631364, NACOGDOCHES, TX, 75963, US

(21) Appl. No.: 10/642,495

(22) Filed: Aug. 18, 2003

(51) Int. Cl. F16M 11/00

(52) U.S. Cl. 248/200; 248/205.1

(57) ABSTRACT

The wheel axle (FIG. 4) utilized on the Chelsea Swing Arm System Assembly is a single axle which allows for the fitment of a sixteen inch, seventeen inch, eighteen inch, nineteen inch, or twenty one inch motorcycle type wheel. The Chelsea Swing Arm System Assembly will retrofit to an existing swing arm chassis or frame design and will maintain low ground clearance.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### BACKGROUND OF INVENTION

There are two basic side car chassis designs or concepts: The hard chassis design has the wheel axle attached directly to the chassis frame and is engineered to match the motorcycle axle height (i.e. the side car chassis axle height is the same as the front and rear axle of the motorcycle), which allows for the fitment of a motorcycle type matching wheel. This design, however, has been criticized in recent years, because it does compromise the passengers safety, especially in corners as the side car wheel has the tendency to lift. At higher speeds above 55 mph, the design allows for wind buffeting.

This occurs, as there is more area under the side car body for the wind to drive the body upward, creating a rocking front to rear, up and down motion.

The other chassis design or concept is the swing arm design. The swing arm chassis design allows for the side car chassis to be lowered very close to the ground, as the wheel axle is attached to the swing arm independent from the main chassis frame which expands geometric possibilities. This feature eliminates unsafe wheel lift in corners, and because of the much lower ground clearance, it resolves the wind buffeting problem at higher speeds as well.

All side car manufacturers have been aware recently that markets exist for a motorcycle type wheel match on the swing arm concept chassis. The basic reason for this absence in the industry is that until now they have had utilize a 13-inch diameter or less trailer or automotive lug type wheel to allow for the much lower ground clearance desired for safety or stability in corners and higher speeds.

While there are side car chassis being produced that utilize a swing arm concept and shock absorber as opposed to a hard chassis with a main leaf spring, there are no known side car swing arm chassis being produced that will allow the swing arm wheel axle to accommodate the fitment of a motorcycle type wheel.

### BRIEF SUMMARY OF THE INVENTION

The Chelsea Swing Arm System Assembly does address the past inability to install a motorcycle type wheel as opposed to a small diameter trailer or automotive lug type wheel on a motorcycle side car chassis with an existing swing arm concept chassis. This system retains the low ground clearance preferred in today's market for passenger safety. The larger diameter motorcycle wheel-tire capability also adds to safety because of more tire surface to the ground which improves stability.

### BRIEF DESCRIPTION OF THE SEVERAL VIEWS OF THE DRAWINGS

FIG. 00 is a completed Chelsea Swing Arm System Assembly.

FIG. 1 is a detailed drawing of the Chelsea Swing Arm System Assembly mounting plate component.

FIG. 2 is a detailed drawing of the Chelsea Swing Arm System Assembly swing arm main shaft component.

FIG. 3 is a detailed drawing of the Chelsea Swing Arm System Assembly shock absorber mount component.

FIG. 4 is a detailed drawing of the Chelsea Swing Arm System Assembly axle shaft component.

### DETAILED DESCRIPTION OF THE INVENTION

The Chelsea Swing Arm System Assembly was invented so as to allow for the fitment of a motorcycle type wheel on a motorcycle side car with a swing arm concept chassis.

The material type used in manufacturing the Chelsea Swing Arm System Assembly mounting plate component was 4140 steel. The material type used in manufacturing all other Chelsea Swing Arm System Assembly components were 1045 steel. The rough dimensions of the material utilized were as follows: 1.000×4.0625×13.0 plate steel; 1.2500×4.000 round stock; 1.3750×10.0 round stock; 1.5000×8.0 round stock.

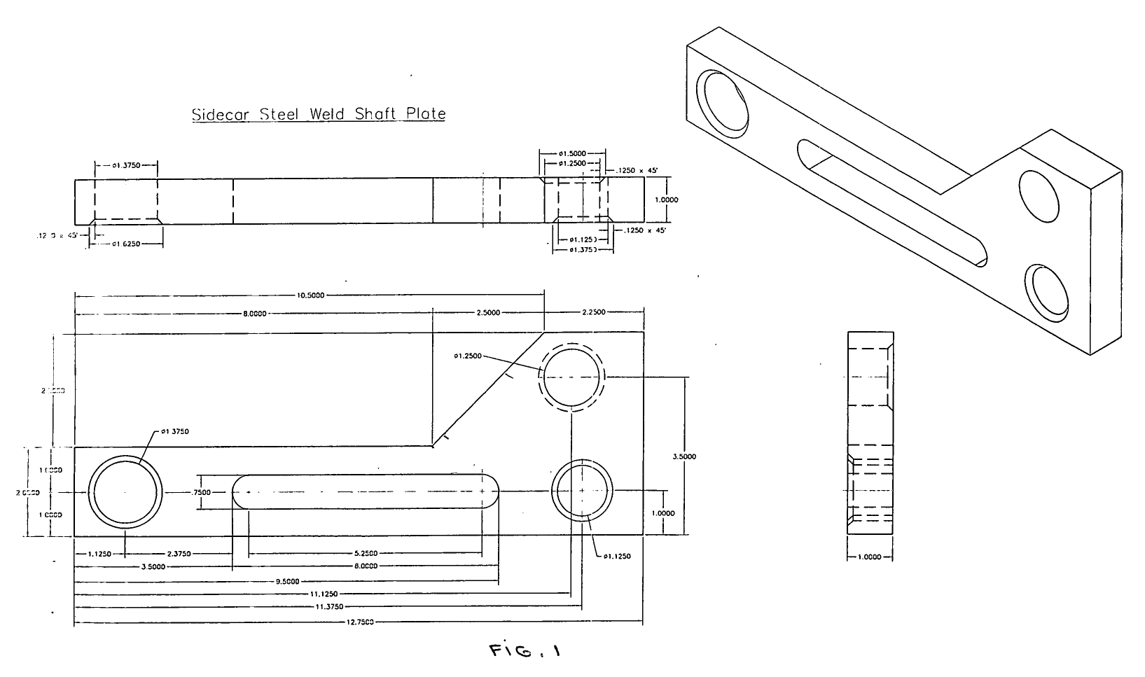

The swing arm plate component was manufactured by flame cutting the plate to nominal size. The three shaft mounting holes were then bored into the plate with a milling machine, so as to allow for a press fit. The plate was then milled on all surfaces to a mill finish (refer To FIG. 1 drawing—swing arm mounting plate).

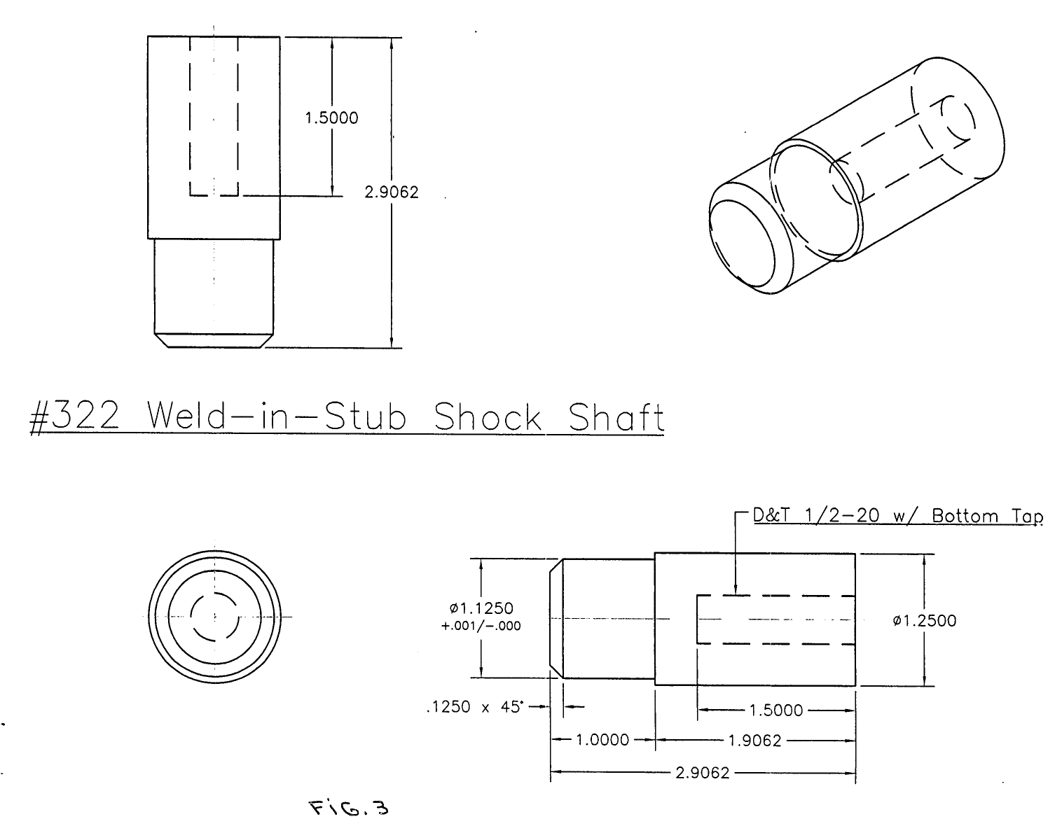

The 1.2500 round stock was cut to the nominal length. The stock was faced off on a lathe. The shaft was then turned to size. The threaded end was drilled and tapped to size. The shaft was then turned to a press fit size with a shoulder as a seat and a weld bevel on the opposite end (refer to FIG. 3 drawing—shock absorber mount).

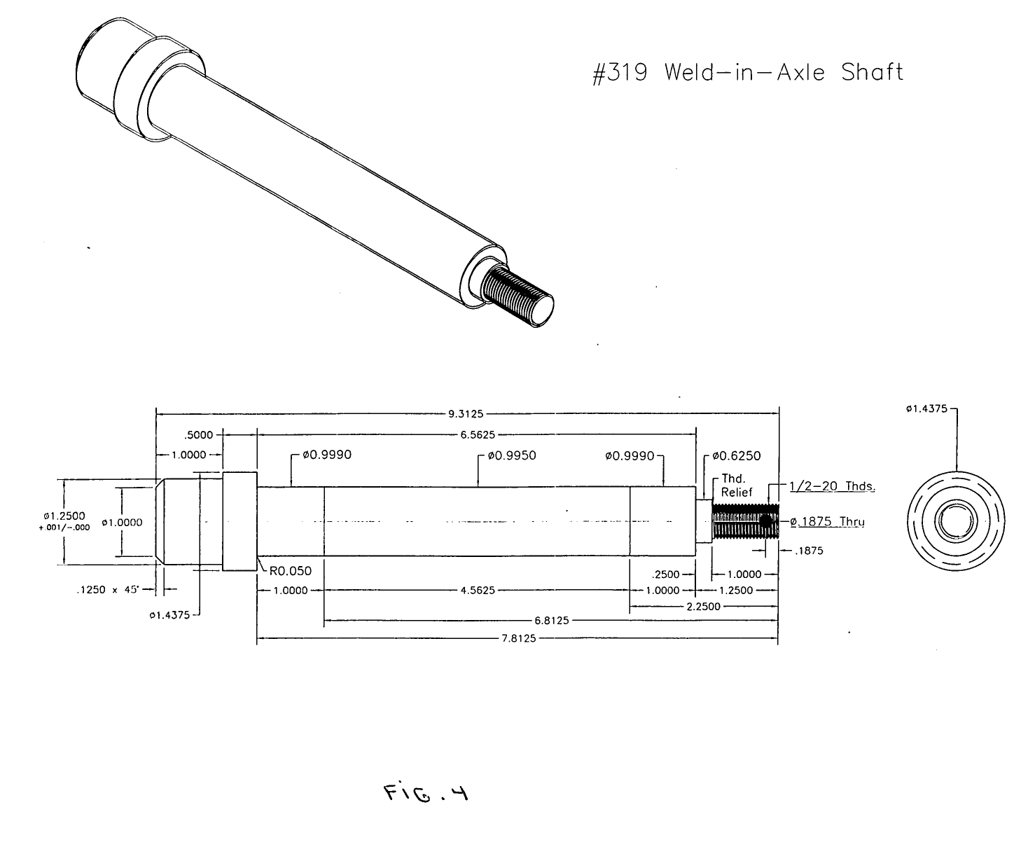

The 1.3750 round stock was cut to nominal length. The stock was then faced off on a lathe. The shaft was then turned to size. The shaft was threaded and also drilled for a 0.1250 cotter pin. The shaft was then turned to a press fit size with a shoulder as a seat and a weld bevel on the opposite end (refer to FIG. 4 drawing-axle shaft).

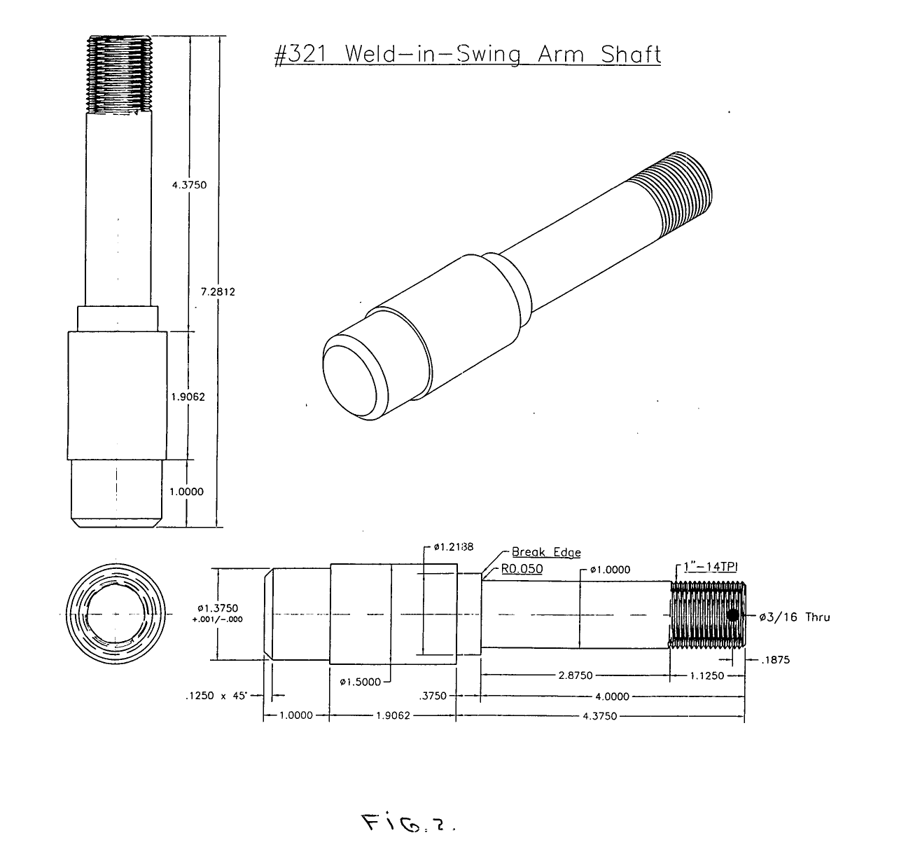

The 1.5000 round stock was cut to nominal length. The stock was then faced off on a lathe. The shaft was then turned to size. The shaft was then threaded and drilled for a 0.01250 cotter pin. The shaft was then turned to a press fit with a shoulder seat and weld bevel on the opposite end (refer to FIG. 2 drawing—main swing arm shaft).

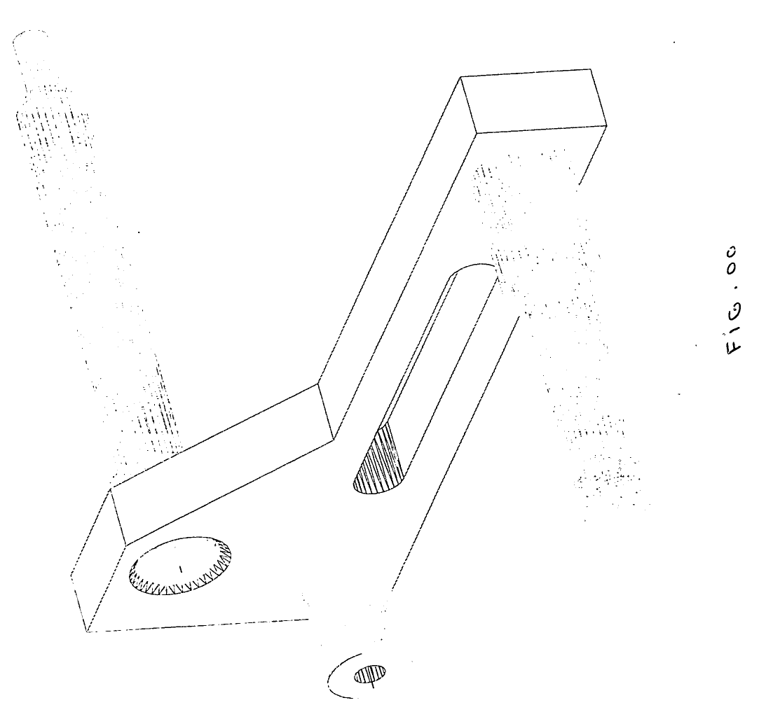

The last procedure was to quality control check all components, then press the three shaft components into the plate component with a 50 ton press and weld them from the back side (refer to FIG. 00 drawing—system assembly).

1. A swing arm system assembly that allows for the fitment of a motorcycle front wheel to be retrofitted to any motorcycle side car chassis or frame with an existing swing arm chassis design that currently utilizes a 13-inch diameter or less trailer or automotive lug type wheel.
